(19) United States
(12) Patent Application Publication
(10) Pub. No.: US 2009/0303423 A1
(43) Pub. Date: Dec. 10, 2009

(54) LIQUID CRYSTAL DISPLAY AND A METHOD FOR MANUFACTURING THE SAME

(76) Inventors: Woong-Kwon KIM, Cheonan-si (KR); Jun-Ho SONG, Seongnam-si (KR)

Correspondence Address: F. CHAU & ASSOCIATES, LLC, 130 WOODBURY ROAD, WOODBURY, NY, 11797, US

(21) Appl. No.: 12/400,261

(22) Filed: Mar. 9, 2009

(30) Foreign Application Priority Data
Jun. 5, 2008 (KR) 10-2008-0053049

(51) Int. Cl. G02F 1/1339; G02F 1/1333; G02F 1/13

(52) U.S. Cl. 349/110; 349/155; 349/187

(57) ABSTRACT

A liquid crystal display including: a first substrate; a gate line and a data line formed on the first substrate and crossing each other; a thin film transistor connected to the gate line and the data line; an insulating layer formed on the gate line and the data line, and including an opening; a pixel electrode connected to the thin film transistor; a first spacer formed in the opening; and a second spacer formed on the insulating layer, wherein a distance from a top surface of the insulating layer to a top surface of the first spacer is different from a distance from the top surface of the insulating layer to a top surface of the second spacer.

### CROSS-REFERENCE TO RELATED APPLICATION

This application claims priority to Korean Patent Application No. 10-2008-0053049 filed in the Korean Intellectual Property Office on Jun. 5, 2008, the disclosure of which is incorporated by reference herein in its entirety.

### BACKGROUND OF THE INVENTION

1. Technical Field

The present invention relates to a display device, and more particularly, to a liquid crystal display including spacers.

2. Discussion of the Related Art

A liquid crystal display (LCD) is one of the most widely used flat panel displays. For example, an LCD can be found in a variety of electronic devices such as televisions, laptop computers, personal digital assistants, cell phones and digital cameras.

An LCD is composed of two display panels on which field generating electrodes are formed, and a liquid crystal layer interposed between the two display panels. The LCD displays an image by applying a voltage to the field generating electrodes to generate an electric field in the liquid crystal layer that determines the orientation of liquid crystal molecules therein to adjust polarization of incident light.

In general, an LCD has field generating electrodes respectively formed on two display panels. For example, a plurality of pixel electrodes and thin film transistors are arranged in a matrix on one display panel, and color filters of red, green, and blue and a common electrode are formed on the other display panel.

However, since the pixel electrodes and the color filters are disposed on different display panels, the pixel electrodes and the color filters may not be aligned with each other.

To prevent this from happening, a color filter on array (COA) structure in which the pixel electrode and the color filter are formed on the same display panel has been developed. However, in the COA structure, contact deterioration may occur where the pixel electrode and the thin film transistor touch.

A dual column spacer structure including a main spacer in contact with both display panels and an assistance spacer having an end in contact with one display panel has also been developed to prevent misalignment. However, the main spacer and the assistance spacer are generally provided on the display panel having the common electrode. Moreover, the spacers generally have a different length from each other. As a result, the process of manufacturing such a structure is complicated.

Accordingly, there is a need for a display device with aligned pixel electrodes and color filters that can be manufactured in a less complicated fashion and that can reduce contact deterioration between pixel electrodes and thin film transistors.

### SUMMARY OF THE INVENTION

A liquid crystal display according to an exemplary embodiment of the present invention includes: a first substrate; a gate line and a data line formed on the first substrate and crossing each other; a thin film transistor connected to the gate line and the data line; an insulating layer formed on the gate line and the data line, and including an opening; a pixel electrode connected to the thin film transistor; a first spacer formed in the opening; and a second spacer formed on the insulating layer, wherein a distance from a top surface of the insulating layer to a top surface of the first spacer is different from a distance from the top surface of the insulating layer to a top surface of the second spacer.

A second substrate facing the first substrate and provided with a common electrode, and a liquid crystal layer interposed between the first substrate and the second substrate may further be included, wherein the second substrate is in contact with the second spacer and is separated from the first spacer.

The pixel electrode may include a first pixel electrode and a second pixel electrode.

A color filter formed between the first pixel electrode and the second pixel electrode may further be included, wherein the color filter is disposed in the opening.

The first pixel electrode may be connected to the thin film transistor under the color filter, and the second pixel electrode may be connected to the first pixel electrode on the insulating layer.

The insulating layer may comprise a light blocking member.

The top surface of the light blocking member may have a step. The first pixel electrode and the second pixel electrode may be made of the same material.

A thin film transistor array panel according to an exemplary embodiment of the present invention includes: a first substrate; a gate line formed on the first substrate, and including a gate electrode; a gate insulating layer formed on the gate line; a semiconductor formed on the gate insulating layer and overlapping the gate electrode; a data line formed on the semiconductor and including a source electrode; a drain electrode formed on the semiconductor and facing the source electrode; a light blocking member formed on the gate line and the data line; a passivation layer formed on the gate insulating layer, the source electrode, the drain electrode, and the light blocking member, and including a first contact hole exposing the drain electrode; a first pixel electrode formed on the passivation layer, and connected to the drain electrode through the first contact hole; a color filter formed on the first pixel electrode, and disposed in a pixel area except for a first region that includes part of the source electrode and part of the drain electrode in the pixel area; a second pixel electrode formed on the color filter and the light blocking member; a first spacer formed in the first region; and a second spacer formed on the light blocking member.

A length of the first spacer and a length the second spacer may be substantially the same.

The surface of the light blocking member may have a step.

The second pixel electrode may be connected to the first pixel electrode on the light blocking member.

The first pixel electrode and the second pixel electrode may be made of the same material.

An insulating layer formed between the light blocking member and the data line, and on the drain electrode may further be included.

A method for manufacturing a liquid crystal display according to an exemplary embodiment of the present invention includes: forming a gate line including a gate electrode on a first substrate; forming a gate insulating layer on the gate line; forming a semiconductor on the gate insulating layer; forming a data line including a source electrode, and a drain electrode facing the source electrode on the semiconductor; forming a light blocking member on the gate line and the data line; forming a passivation layer including a first contact hole exposing the drain electrode on the gate insulating layer, the source electrode, the drain electrode, and the light blocking member; depositing a first pixel electrode layer connected to the drain electrode through the first contact hole on the passivation layer; forming a color filter on the first pixel electrode layer in a pixel area except for a first region that includes part of the source electrode and part of the drain electrode in the pixel area; depositing a second pixel electrode layer on the color filter and the first pixel electrode layer; etching the second pixel electrode layer and the first pixel electrode layer by photolithography to form a second pixel electrode and a first pixel electrode; forming a first spacer in the first region and a second spacer on the light blocking member.

The method may further include forming a common electrode on a second substrate, and assembling the first substrate and the second substrate, wherein the second substrate may be in contact with the second spacer and separated from the first spacer.

When forming the light blocking member, the light blocking member may be exposed and a half-tone mask is used to form a step on a surface of the light blocking member.

The second pixel electrode may be connected to the first pixel electrode on the light blocking member.

The first pixel electrode and the second pixel electrode may be made of the same material.

The method may further include forming an insulating layer between the light blocking member and the data line, and on the drain electrode.

### BRIEF DESCRIPTION OF THE DRAWINGS

FIG. 1 is a layout view of a liquid crystal display according to an exemplary embodiment of the present invention.

FIG. 2 is a cross-sectional view of the liquid crystal display shown in FIG. 1 taken along line II-II.

FIG. 3 to FIG. 9 are cross-sectional views of the liquid crystal display shown in FIG. 1 and FIG. 2 sequentially showing a manufacturing method thereof according to an exemplary embodiment of the present invention.

### DETAILED DESCRIPTION OF EXEMPLARY EMBODIMENTS

The present invention will be described more fully hereinafter with reference to the accompanying drawings, in which exemplary embodiments of the invention are shown. The present invention may, however, be embodied in many different forms and should not be construed as limited to the embodiments set forth herein.

In the drawings, the thickness of layers, films, panels, regions, etc., may be exaggerated for clarity. Like reference numerals designate like elements throughout the specification. It will be understood that when an element such as a layer, film, region, or substrate is referred to as being “on” another element, it can be directly on the other element or intervening elements may also be present.

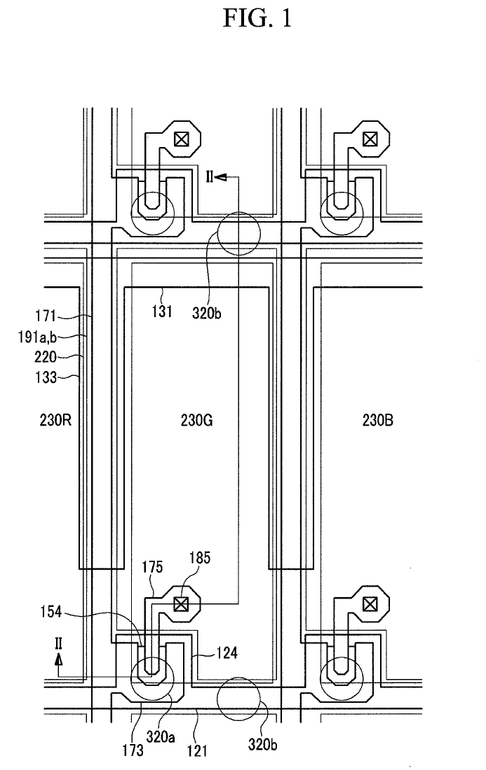

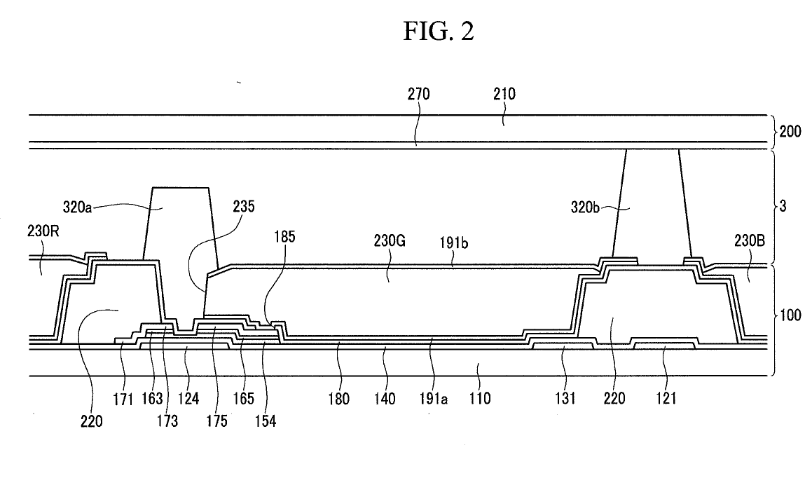

Now, a display device according to an exemplary embodiment of the present invention will be described with reference to FIG. 1 and FIG. 2.

FIG. 1 is a layout view of a liquid crystal display according to an exemplary embodiment of the present invention, and FIG. 2 is a cross-sectional view of the liquid crystal display shown in FIG. 1 taken along line II-II.

Referring to FIG. 1 and FIG. 2, a liquid crystal display according to the present exemplary embodiment includes a thin film transistor array panel 100 and a common electrode panel 200 facing each other, a liquid crystal layer 3 disposed between the two display panels 100 and 200, and a plurality of spacers 320a and 320b.

First, the thin film transistor array panel 100 will be described.

The thin film transistor array panel 100 includes a plurality of structures. In detail, in the structures, a plurality of gate lines 121 and a plurality of storage electrode lines 131 are formed on a substrate 110 of an insulating material such as glass or plastic. A gate insulating layer 140 is formed thereon, and a plurality of semiconductors 154, a plurality of ohmic contacts 163 and 165, a plurality of data lines 171, and a plurality of drain electrodes 175 are sequentially formed thereon.

The gate lines 121 transmit gate signals and substantially extend in a transverse direction. Each gate line 121 includes a plurality of gate electrodes 124 extending upward.

The storage electrode lines 131 are applied with a predetermined voltage such as a common voltage, and are parallel to the gate lines 121, and each storage electrode line 131 includes a plurality of storage electrodes 133 extending downward and overlapping the data lines 171. Each storage electrode line 131 is disposed between two neighboring gate lines 121 and maintains the same interval between the two neighboring gate lines 121.

The data lines 171 transmit data signals, and extend substantially in the longitudinal direction thereby crossing the gate lines 121. Each data line 171 includes a plurality of source electrodes 173 extending toward the gate electrodes 124. The drain electrodes 175 are separated from the data lines 171 and are opposite to the source electrodes 173 with respect to the gate electrode 124.

The semiconductors 154 are disposed on the gate electrodes 124, and the ohmic contacts 163 and 165 are disposed between the semiconductors 154 above, and the data lines 171 and the drain electrodes 175 thereunder, and reduce a contact resistance therebetween.

One gate electrode 124, one source electrode 173 and one drain electrode 175 form one thin film transistor (TFT) along with one semiconductor 154, and a channel of the thin film transistor is formed in the semiconductor 154 between the source electrode 173 and the drain electrode 175.

A light blocking member 220, which is referred to as a black matrix, is formed on the gate lines 121 and the data lines 171.

A passivation layer 180 is formed on the gate insulating layer 140, the data lines 171, the drain electrodes 175, and the light blocking member 220. The passivation layer 180 has a plurality of first contact holes 185 exposing the drain electrodes 175.

A plurality of first pixel electrodes 191a are formed on the passivation layer 180. The first pixel electrodes 191a may be made of a transparent conductive material such as indium tin oxide (ITO) or indium zinc oxide (IZO), or a reflective metal such as aluminum or a silver alloy, and are connected to the drain electrode 175 through the first contact holes 185.

Color filters 230R, 230G, and 230B are formed on the first pixel electrodes 191a. The color filters 230R, 230G, and 230B are disposed in pixel areas. A pixel area may be defined by the light blocking member 220, but is not limited thereto. Here, each color filter 230R, 230G, and 230B is respectively formed on the pixel electrode 191a in a pixel area except for a region corresponding to the thin film transistor thereby forming a groove 235.

A plurality of second pixel electrodes 191b are formed on the color filters 230R, 230G, and 230B. The second pixel electrode 191b may be made of a transparent conductive material such as ITO or IZO, and may contact the first pixel electrode 191a on the light blocking member 220.

The second pixel electrodes 191b prevent the color filters 230R, 230G, and 230B from being lifted and prevent a chemical solution such as an etchant from flowing into the color filters 230R, 230G, and 230B.

For example, the first pixel electrodes 191a are in contact with the drain electrodes 175 under the color filters 230R, 230G, and 230B, and the first pixel electrodes 191a are in contact with the second pixel electrodes 191b on the light blocking member 220 such that it is not necessary to form a contact hole in the color filters 230R, 230G and 230B or an organic layer for connecting the pixel electrode 191a and the drain electrode 175 to each other. Accordingly, contact deterioration between the pixel electrode 191a and the drain electrode 175 due to the formation of such a contact hole may be prevented.

The common electrode panel 200 is opposite the thin film transistor array panel 100 and includes a common electrode 270 formed on a substrate 210. However, the common electrode 270 may be formed on the thin film transistor array panel 100.

The liquid crystal layer 3 is disposed between the common electrode panel 200 and the thin film transistor array panel 100.

A plurality of spacers including the first spacers 320a and the second spacers 320b are formed between the common electrode panel 200 and the thin film transistor array panel 100, and the thickness of the liquid crystal layer 3 may be determined by the spacers.

The lengths of the first spacer 320a and the second spacer 320b are substantially the same. The first spacers 320a are disposed in the groove 235 on the thin film transistor, and the second spacers 320b are disposed on the light blocking member 220. Accordingly, the top of the second spacer 320b is higher than the top of the first spacer 320a.

The second spacer 320b is in contact with the common electrode panel 200, and maintains the distance between the thin film transistor array panel 100 and the common electrode panel 200. The second spacers 320b have elasticity such that they may be compressed by an external force and then return to their non-compressed form.

The first spacers 320a are separated from the common electrode panel 200 such that if the second spacer 320b is applied with the external force, they come in contact with the common electrode panel 200 and the external force applied to the second spacer 320b is dispersed. Accordingly, damage to the second spacers 320b caused by the external force may be prevented.

For example, by using the dual spacer structure including the first spacers 320a and the second spacers 320b having top surfaces thereof at different heights, as compared with a single spacer, a margin of the liquid crystal is increased. Accordingly, active unfilled area (AUA) deterioration, where light leakage is caused due to an insufficient amount of the liquid crystal, and gravity deterioration, where the liquid crystal is excessively filled in the direction of gravity, may be prevented.

The interval between the first spacer 320a and the common electrode panel 200 may be the same as the depth of the groove 235 formed in the color filters 230R, 230G, and 230B.

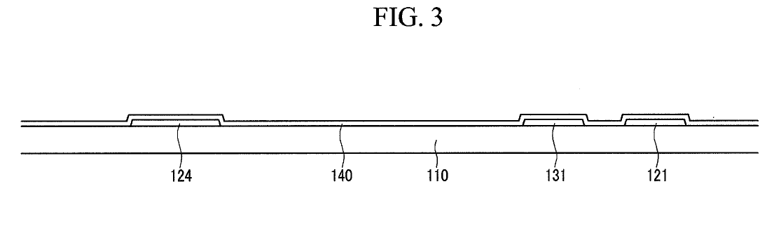

Next, a manufacturing method of the liquid crystal display shown in FIG. 1 and FIG. 2 according to an exemplary embodiment of the present invention will be described with reference to FIG. 3 to FIG. 9, as well as FIG. 1 and FIG. 2.

FIG. 3 to FIG. 9 are cross-sectional views of the liquid crystal display shown in FIG. 1 and FIG. 2 sequentially showing a manufacturing method thereof.

First, as shown in FIG. 3, a gate line 121 including a gate electrode 124 and a storage electrode line 131 are formed on an insulating substrate 110, and a gate insulating layer 140 is formed on the whole surface of the insulating substrate 110 including the gate line 121 and the storage electrode line 131.

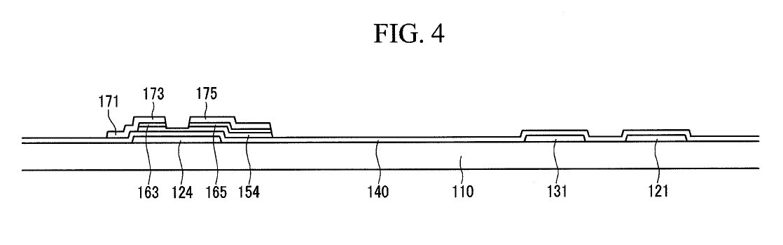

Next, as shown in FIG. 4, a semiconductor 154, ohmic contact layers 163 and 165, a data line 171 including a source electrode 173, and a drain electrode 175 are formed on the gate insulating layer 140.

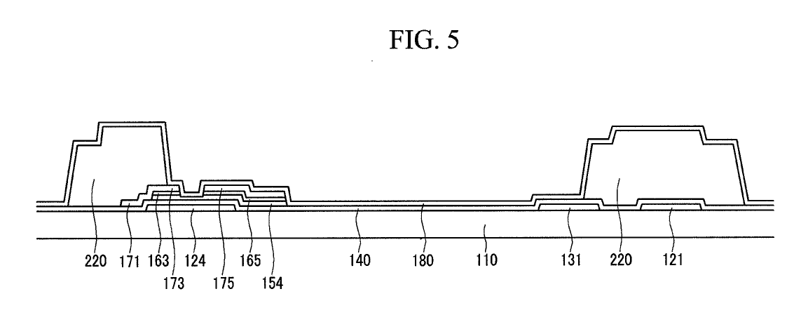

Next, as shown in FIG. 5, a light blocking member 220 is formed on the gate line 121 and the data line 171. Here, a step is formed on the upper surface of the light blocking member 220 to prevent the color filters 230R, 230G, and 230B that will be formed later from being overlapped. A half tone mask may be used to form the step in the light blocking member 220 during an exposure process when forming the light blocking member 220. For example, a positive photoresist including black color pigments is coated and exposed. Here, a light blocking portion of the mask is disposed on a portion of the photoresist corresponding to the higher step portion of the light blocking member 220, and a slit portion of the mask is disposed on a portion of the photoresist corresponding to the lower step portion of the light blocking member 220, and a transparent portion of the mask is disposed on a portion of the photoresist corresponding to where the light blocking member 220 does not exist, thereby forming the light blocking member 220 having the step.

Next, a passivation layer 180 is formed on the insulating substrate 110.

Before forming the light blocking member 220 a passivation layer may be formed for stabilizing the characteristics of the processes and the elements.

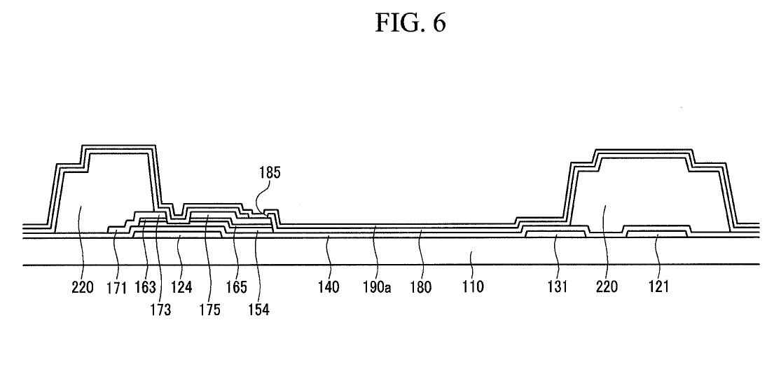

Next, as shown in FIG. 6, the passivation layer 180 is etched to form a contact hole 185 exposing the drain electrode 175, and a transparent conductive material, such as ITO or IZO, or a reflective metal, such as aluminum or a silver alloy, is formed on the passivation layer 180 and patterned to form the first pixel electrode layer 190a. The first pixel electrode layer 190a is connected to the drain electrode 175 through the first contact hole 185.

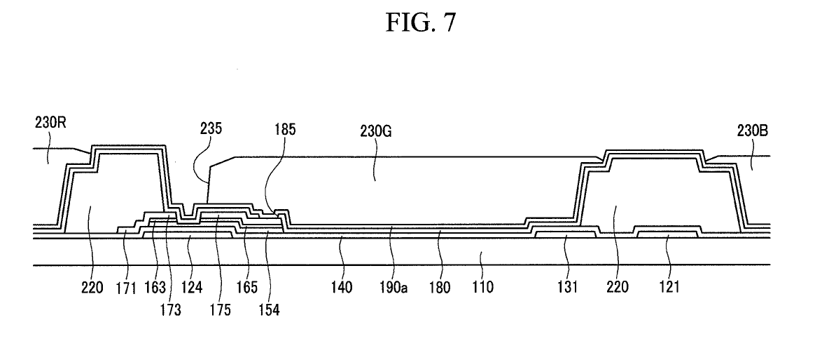

Next, as shown in FIG. 7, color filters 230R, 230G, and 230B are formed in the pixel areas, which according to a non-limiting embodiment of the present invention, are defined by the light blocking member 220 on the first pixel electrode layer 190a. Here, the color filters 230R, 230G, and 230B may be formed by inkjet printing. In the inkjet printing technique, liquid ink is dispersed on a predetermined pixel area thereby providing images colored by each ink. Thus, the plurality of color filters 230R, 230G, and 230B, including a red filter 230R, a green filter 230G, and a blue filter 230B, may be formed through one process such that the number of manufacturing steps, and the manufacturing time and cost may be reduced. Here, the overlap of the color filters 230R, 230G, and 230B may be prevented by the step of the light blocking member 220. Next, a groove 235 exposing the first pixel electrode layer 190a on the thin film transistor is formed in the color filters 230R, 230G, and 230B.

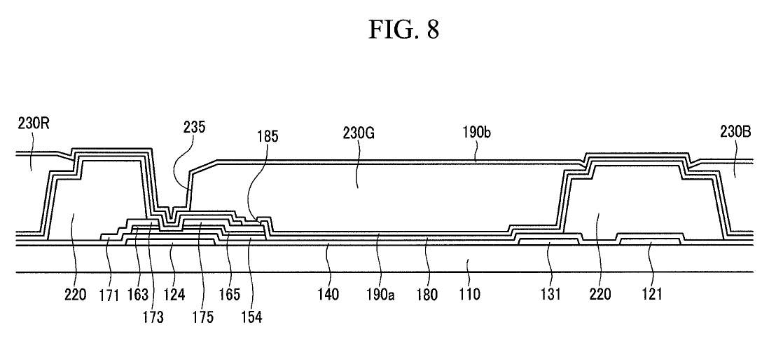

Next, as shown in FIG. 8, the second pixel electrode layer 190b made of a transparent conductive material, such as ITO or IZO, is formed on the color filters 230R, 230G, and 230B.

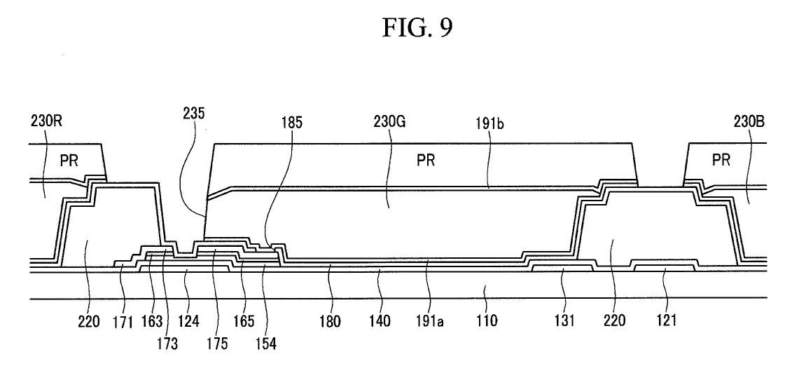

Next, as shown in FIG. 9, a photosensitive film pattern PR is formed on the pixel electrode layer 190b corresponding to a second pixel electrode 191b, and the first pixel electrode layer 190a and the second pixel electrode layer 190b, which are disposed in the groove 235 on the thin film transistor, and on the light blocking member 220 are etched by using the photosensitive film pattern PR as an etch mask to form the first pixel electrode 191a and the second pixel electrode 191b. Here, when the first pixel electrode layer 190a and the second pixel electrode layer 190b are made of the same material, the two layers 190a and 190b may be simultaneously etched by using one etchant.

For example, the first pixel electrode 191a and the drain electrode 175 are connected to each other under the color filters 230R, 230G, and 230B, and the first pixel electrode 191a and the second pixel electrode 191b are connected to each other on the light blocking member 220 such that it is not necessary to form a contact hole in the color filters 230R, 230G and 230B or an organic layer for connecting the pixel electrode 191a and the drain electrode 175 to each other. Accordingly, contact deterioration between the pixel electrode 191a and the drain electrode 175 due to the formation of such a contact hole may be prevented.

Next, as shown in FIG. 2, the first spacer 320a and the second spacer 320b are formed. The first spacer 320a is disposed in the groove 235, and the second spacer 320b is disposed on the light blocking member 220. The first spacer 320a and the second spacer 320b are simultaneously formed and the lengths thereof are substantially the same, however the top of the second spacer 320b is higher than the top of the first spacer 320a. Accordingly, the manufacturing process of the dual spacer structure including the first and second spacers 320a and 320b having different heights is simplified.

To form the common electrode panel 200, a common electrode 270 is deposited on an insulating substrate 210.

Then, a liquid crystal is dripped on one of the thin film transistor array panel 100 and the common electrode panel 200, and the two display panels 100 and 200 are assembled.

According to an exemplary embodiment of the present invention, the spacers are respectively disposed in contact holes exposing the thin film transistor and the light blocking member such that the spacers can have substantially the same length. Thus, the spacers do not need different lengths, therefore, the manufacturing process thereof can be simplified. In addition, since the connection between the pixel electrode and the thin film transistor is made before forming the color filters, the contact deterioration that results due to the formation of a contact hole in a color filter for connecting the thin film transistor with the pixel electrode is prevented.

While the present invention has been described in detail with reference to the exemplary embodiments, those skilled in the art will appreciate that various modifications and substitutions can be made thereto without departing from the spirit and scope of the present invention as set forth in the appended claims. For example, although the exemplary embodiments of the present invention have been described with reference to a liquid crystal display, they may be adapted to various kinds of display devices.

What is claimed is:

1. A liquid crystal display, comprising:
a first substrate;
a gate line and a data line formed on the first substrate and crossing each other;
a thin film transistor connected to the gate line and the data line;
an insulating layer formed on the gate line and the data line, and including an opening;
a pixel electrode connected to the thin film transistor;
a first spacer formed in the opening; and
a second spacer formed on the insulating layer,
wherein a distance from a top surface of the insulating layer to a top surface of the first spacer is different from a distance from the top surface of the insulating layer to a top surface of the second spacer.

2. The liquid crystal display of claim 1, further comprising:
a second substrate facing the first substrate, and provided with a common electrode; and
a liquid crystal layer interposed between the first substrate and the second substrate,
wherein the second substrate is in contact with the second spacer and is separated from the first spacer.

3. The liquid crystal display of claim 2, wherein the pixel electrode includes a first pixel electrode and a second pixel electrode.

4. The liquid crystal display of claim 3, further comprising:
a color filter formed between the first pixel electrode and the second pixel electrode,
wherein the color filter is disposed in the opening.

5. The liquid crystal display of claim 4, wherein the first pixel electrode is connected to the thin film transistor under the color filter, and the second pixel electrode is connected to the first pixel electrode on the insulating layer.

6. The liquid crystal display of claim 5, wherein the insulating layer comprises a light blocking member.

7. The liquid crystal display of claim 6, wherein the top surface of the light blocking member has a step.

8. The liquid crystal display of claim 3, wherein the first pixel electrode and the second pixel electrode are made of the same material.

9. A thin film transistor array panel, comprising:
a first substrate;
a gate line formed on the first substrate, and including a gate electrode;
a gate insulating layer formed on the gate line;
a semiconductor formed on the gate insulating layer and overlapping the gate electrode;
a data line formed on the semiconductor and including a source electrode;
a drain electrode formed on the semiconductor and facing the source electrode;
a light blocking member formed on the gate line and the data line;
a passivation layer formed on the gate insulating layer, the source electrode, the drain electrode, and the light blocking member, and including a first contact hole exposing the drain electrode;
a first pixel electrode formed on the passivation layer, and connected to the drain electrode through the first contact hole;
a color filter formed on the first pixel electrode, and disposed in a pixel area except for a first region that includes part of the source electrode and part of the drain electrode in the pixel area;
a second pixel electrode formed on the color filter and the light blocking member;
a first spacer formed in the first region; and
a second spacer formed on the light blocking member.

10. The thin film transistor array panel of claim 9, wherein a length of the first spacer and a length of the second spacer are substantially the same.

11. The thin film transistor array panel of claim 10, wherein a surface of the light blocking member has a step.

12. The thin film transistor array panel of claim 11, wherein the second pixel electrode is connected to the first pixel electrode on the light blocking member.

13. The thin film transistor array panel of claim 12, wherein the first pixel electrode and the second pixel electrode are made of the same material.

14. The thin film transistor array panel of claim 9, further comprising:
an insulating layer formed between the light blocking member and the data line, and on the drain electrode.

15. A method for manufacturing a liquid crystal display, comprising:
forming a gate line including a gate electrode on a first substrate;
forming a gate insulating layer on the gate line;
forming a semiconductor on the gate insulating layer;
forming a data line including a source electrode, and a drain electrode facing the source electrode on the semiconductor;
forming a light blocking member on the gate line and the data line;
forming a passivation layer including a first contact hole exposing the drain electrode on the gate insulating layer, the source electrode, the drain electrode, and the light blocking member;
depositing a first pixel electrode layer connected to the drain electrode through the first contact hole on the passivation layer;
forming a color filter on the first pixel electrode layer in a pixel area except for a first region that includes part of the source electrode and part of the drain electrode in the pixel area;
depositing a second pixel electrode layer on the color filter and the first pixel electrode layer;
etching the second pixel electrode layer and the first pixel electrode layer by photolithography to form a second pixel electrode and a first pixel electrode;
forming a first spacer in the first region and a second spacer on the light blocking member.

16. The method of claim 15, further comprising:
forming a common electrode on a second substrate; and
assembling the first substrate and the second substrate,
wherein the second substrate is in contact with the second spacer, and is separated from the first spacer.

17. The method of claim 16, wherein when forming the light blocking member, the light blocking member is exposed and a half-tone mask is used to form a step on a surface of the light blocking member.

18. The method of claim 17, wherein the second pixel electrode is connected to the first pixel electrode on the light blocking member.

19. The method of claim 15, wherein the first pixel electrode and the second pixel electrode are made of the same material.

20. The method of claim 15, further comprising:
forming an insulating layer between the light blocking member and the data line, and on the drain electrode.
